(19) United States
(12) Patent Application Publication
(10) Pub. No.: US 2017/0199991 A1
(43) Pub. Date: Jul. 13, 2017

(54) METHOD FOR CREATING ACTIVE CONTENT AND COMPUTER-READABLE RECORDING MEDIUM FOR STORING THE ACTIVE CONTENT

(71) Applicant: Sangmyung University Seoul Industry-Academy Cooperation Foundation, Seoul (KR)

(72) Inventor: Sang-ug KANG, Seoul (KR)

(73) Assignee: Sangmyung University Seoul Industry-Academy Cooperation Foundation, Seoul (KR)

(21) Appl. No.: 15/177,677

(22) Filed: Jun. 9, 2016

(30) Foreign Application Priority Data
Jan. 12, 2016 (KR) 10-2016-0003533

(51) Int. Cl. G06F 21/12

(52) U.S. Cl. CPC G06F 21/125; G06F 2221/0731

(57) ABSTRACT

Disclosed is active content. The active content includes at least content that is capable of being played by a player and content control code, which is executable in a computer, for controlling the content depending on an intention parameter, wherein the intention parameter is set in order to control at least playback or distribution of the content.

### BACKGROUND OF THE INVENTION

Field of the Invention

The present invention relates generally to a method for creating active content and a computer-readable recording medium in which the active content is stored. More particularly, the present invention relates to a method for creating active content in which a content owner's intention is contained in order to execute and manage the content according to the content owner's intention, and a computer-readable recording medium in which the active content is stored.

Description of the Related Art

After video or audio content having a file format such as JPEG, MPEG, MP3, or the like, is distributed from the producer of the content, the producer loses control of the content. In other words, the distributed content may be repeatedly produced through copying, printing or the like, and may be unlimitedly played or reproduced regardless of the intention or will of the rightful owner of the content.

Various content protection techniques have been introduced in order to protect content producers' rights to content. As typical methods for protecting content, there are a Digital Rights Management (DRM) method, a personal information protection method in Social Network Service (SNS), a data-hiding method, a digital aging method, and the like.

In order to protect copyright of digital content, DRM uses a cryptographic method, a key distribution method and a system control method throughout the distribution process, and thereby controls the copying of content, content usage rules, and the like. However, a DRM method has problems in that it is inconvenient and it is difficult to secure interoperability when an individual uses the method, but there is no obvious solution to the problems.

Recently, mobile messenger users who feel fatigued with sharing and spreading of content in SNS tend to select ‘self-destructing applications’, by which messages, pictures, or the like are automatically deleted after a certain time period. Self-destructing applications in SNS depend on functions provided by a service provider, and if a desired function is not provided by the service provider, the content may not be shared the way the content owner desires.

Meanwhile, a reversible watermarking technique is known as a technique for hiding specific information in content while maintaining the original information of the content. The reversible watermarking technique may help determine the integrity of content or whether the content has been forged or falsified using the hidden information. The reversible watermarking technique may be applied to the implementation of aging of content or reconstruction of content according to the present invention.

Meanwhile, a digital aging system (Korean Patent No. 10-1258387, disclosed on Apr. 30, 2013 and titled “Digital aging system and management method thereof”, and Korean Patent No. 10-1421666, disclosed on Jul. 22, 2014 and titled “Method for providing file aging service”) provides service in which time to destroy content or deletion of content, which has been uploaded to a website or an app, is managed in a single site, content is prevented from being redistributed or reshared by setting the time to destroy the copyrighted content, and infrequently accessed content is destroyed early so that low-value content may be deleted through file aging.

A known digital aging system provides functions that are not differentiated from the self-destructing functions provided in SNS. Also, because it provides service via a client-server architecture, there may be a problem related to interoperability like the DRM method.

As described above, existing techniques for protecting content have problems in that the holder of content differs from the owner of the content, and that interoperability for content protection is insufficient.

Also, because the protection of content is managed depending on a mere determination of whether to retain or delete content, a mechanism based on human memorization and the forgetfulness of individuals may not be applied.

Therefore, in order to overcome the limitations of existing technology, a device for creating active content, a device for playing active content and a computer-readable recording medium for storing the active content are required.

### SUMMARY OF THE INVENTION

Accordingly, the present invention has been made keeping in mind the above problems, and an object of the present invention is to provide a method for creating active content and a computer-readable recording medium in which the active content is stored, which may create and play the active content in which content is combined with code for controlling the content, representing a departure from the concept of conventional content.

Another object of the present invention is to provide a method for creating active content and a computer-readable recording medium in which the active content is stored, by which the content producer's intention is contained in the active content and the content embedded in the active content may be managed or played based on the intention.

A further object of the present invention is to provide a method for creating active content and a computer-readable recording medium in which the active content is stored, which reject an existing management method based only on the determination of whether to retain or delete content and enable analog memory and forgetting to be applied to the active content for the management thereof.

However, the technical object intended to be accomplished by the present invention is not limited to the above-described technical objects, and other technical objects may be clearly understood by those who skilled in the art through the following description.

A method for creating active content, executed by a computer, according to an aspect of the present invention, includes a parameter creation procedure for creating one or more intention parameters to be used to manage content; a control code configuration procedure for configuring content control code for controlling content depending on the intention parameters, the content control code being executable by a computer; and a content binding procedure for creating active content, in which the content control code is embedded, by combining the content control code with loaded content.

The method for creating active content may further include an input procedure for receiving input for the one or more intention parameters and a selection of content to be loaded from a content creator, wherein in the control code configuration procedure, the content control code may be configured depending on the one or more intention parameters, which are set depending on the input.

In the method for creating active content, the one or more intention parameters may include a playback parameter related to playback of content and a distribution parameter related to distribution of content, and the playback parameter and the distribution parameter each may be represented as a number of times or a time limit.

The method for creating active content may further include a player control code configuration procedure for configuring player control code for controlling a player, which is capable of playing the content, depending on the one or more intention parameters, wherein in the content binding procedure, the active content may be created by combining the player control code, the content control code and the loaded content.

The method for creating active content may further include a security method application procedure for changing the intention parameters, the content control code, or the content, which are combined in the active content, based on a designated security method in order to prevent the one or more intention parameters, the content control code, or the content from being modified or from being extracted from the active content.

In the method for creating active content, the security method may be an obfuscation method, a polymorphic method, or a combination thereof.

In the method for creating active content, an Operating System (OS) header according to a designated software platform may be further combined with the active content in the content binding procedure, and the active content may be recognized as an executable file on the designated software platform.

In a computer-readable recording medium in which active content is stored according to an aspect of the present invention, the active content may include at least content that is capable of being played by a player; and content control code for controlling the content depending on an intention parameter, the content control code being executable in a computer, wherein the intention parameter may be set to control at least playback or distribution of the content.

In the computer-readable recording medium in which active content is stored, the intention parameter may be expressed using a designated markup language, and an action on the content may be controlled depending on the intention parameter.

In the computer-readable recording medium in which active content is stored, the active content may further include player control code for controlling the player depending on the intention parameter.

In the computer-readable recording medium in which active content is stored, the active content may further include an OS header according to a designated software platform, the active content may be recognized as an executable file on an OS of the software platform, and the content may be managed according to the content control code and the player control code within the active content.

In the computer-readable recording medium in which active content is stored, a value of the intention parameter may be changed depending on control of the action on the content, and the changed intention parameter may be stored in the active content.

In the computer-readable recording medium in which active content is stored, the intention parameter, the content control code, or the content may be changed based on a security method in order to prevent the intention parameter, the content control code, and the content from being modified or from being extracted from the active content.

### BRIEF DESCRIPTION OF THE DRAWINGS

The above and other objects, features and other advantages of the present invention will be more clearly understood from the following detailed description when taken in conjunction with the accompanying drawings, in which:

FIG. 1 is a system block diagram of an exemplary system for producing and distributing active content;

FIG. 2 is a hardware block diagram of an exemplary device for creating active content;

FIG. 3 is a functional block diagram of an exemplary device for creating active content; and

FIG. 4 is a block diagram of an exemplary device for playing active content.

### DETAILED DESCRIPTION OF THE INVENTION

The above object, advantages and features of the present invention will be apparent from the following exemplary embodiments, which will be described in detail with reference to the accompanying drawings. Accordingly, a person having ordinary knowledge in the art to which the present invention pertains may easily implement the present invention. Also, repeated descriptions and descriptions of known functions and configurations which have been deemed to make the gist of the present invention unnecessarily obscure will be omitted below. Hereinafter, a preferred embodiment of the present invention will be described in detail with reference to the accompanying drawings.

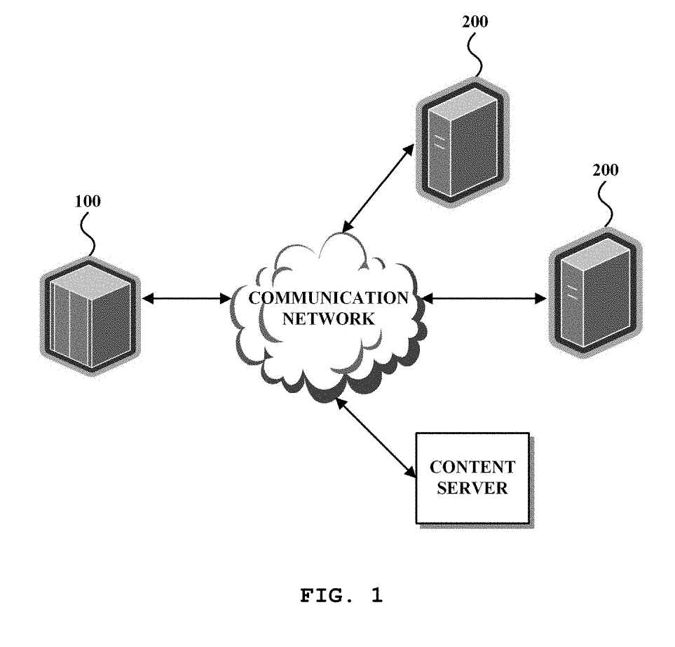

FIG. 1 illustrates a system block diagram of an exemplary system for producing and distributing active content according to the present invention.

Referring to FIG. 1, a system for producing and distributing active content may include one or more active content creation devices 100 and one or more active content playback devices 200, and may further include a content server. Here, the devices and servers may be connected with each other via communication networks, and active content according to the present invention may be distributed through the communication networks.

Here, active content according to the present invention may be executed by computers, and represents an object that is configured such that the functions for content embedded therein can be autonomously executed according to the intention of a content producer. The active content contains not only content that can be managed or played but also program code that is configured to reflect the intention of the content producer in the content. Here, the program code is configured such that application of the intention to the content precedes playback of the content.

Simply describing each of the devices in FIG. 1, the active content creation device 100 is a device for creating active content from playable content. The active content creation device 100 may be a computer in a broad sense, for example, a personal computer, a workstation, a smart phone, a tablet PC, a set-top box, or the like.

The active content creation device 100 packages content in order to enable the execution of a function intended for the stored content. For example, the active content creation device 100 may create active content by loading content based on the input by a user and combining the content, intention parameters, which are set for the content, and control code, which is configured according to the intention parameters, together. Desirably, the created active content may take the form of an executable file. Here, the intention parameters are set so as to control the playback or distribution of the content. The active content may be executed after being produced or distributed, and functions intended for the content may be controlled through embedded code, which is stored along with the content. The intended functions may be related to, for example, playback or distribution of the content.

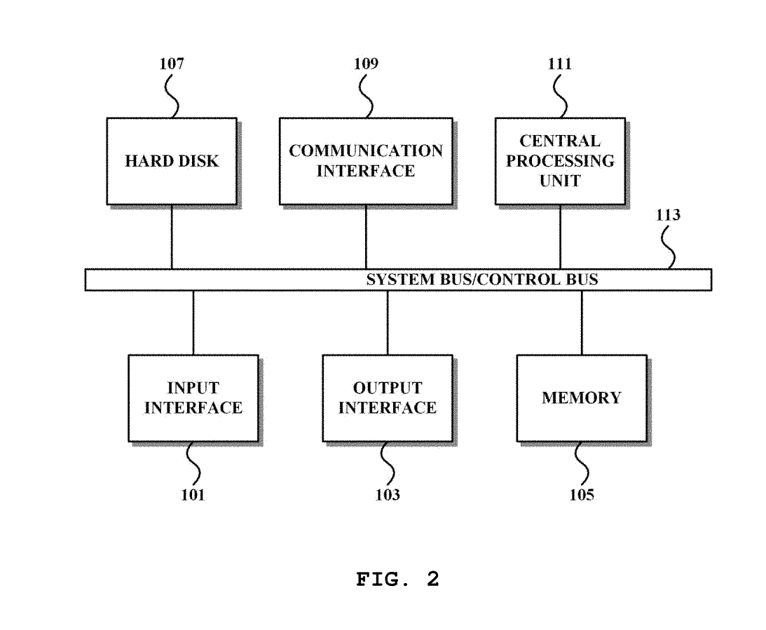

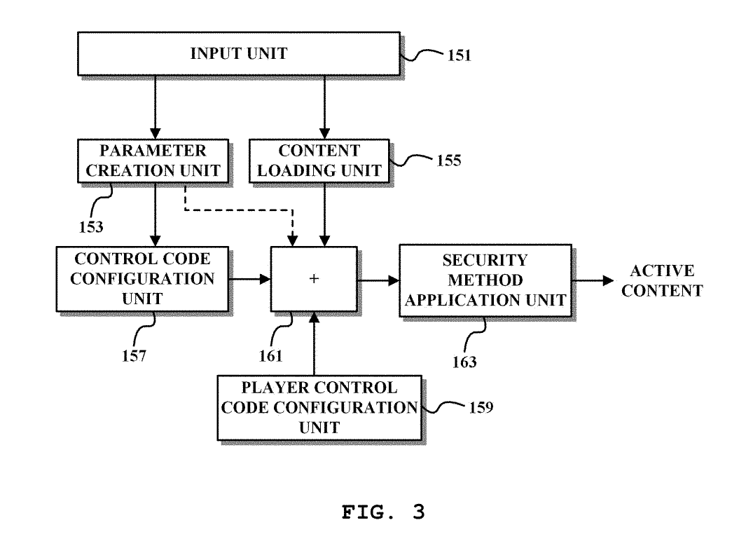

The active content creation device 100 may upload the created active content to a content server or send it to the active content playback device 200 via communication networks. The active content creation device 100 will be described in detail with reference to FIG. 2 and FIG. 3.

The active content playback device 200 is a device that may reproduce the active content created and distributed by the active content creation device 100. The playback device 200 may be, for example, a personal computer, a workstation, a smart phone, a tablet PC, a set-top box, a specialized terminal configured for the present invention, or the like. Each of the personal computers or the smart phones may be referred to as a creation device 100 and/or a playback device 200 based on the function performed on the content.

The active content playback device 200 is configured to be capable of running an executable file defined based on a specific software platform. For example, the active content playback device 200 may execute the program code of a file that is recognized as an executable file on the Operating System (OS), such as Windows or Linux, through an OS header. Desirably, the active content is configured to include (contain) an OS header, control code and content so as to be recognized as an executable file on the corresponding software platform.

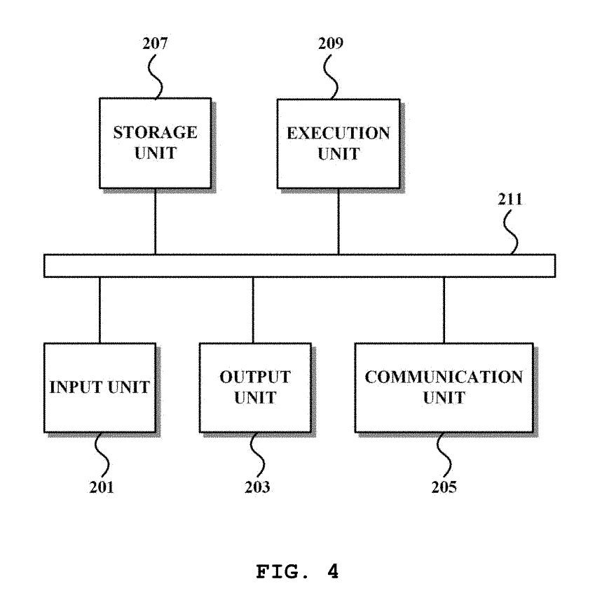

The active content playback device 200 will be described later with reference to FIG. 4.

The content server (a reference numeral for which is not provided) is a device that may store content therein and send content, selected according to a download request, to the terminal that requested the content via a communication network. Also, the content server may store active content according to the present invention, and may send requested active content in response to a download request from the active content playback device 200.

The communication network (a reference numeral for which is not provided) may send and receive data between devices and servers by being located therebetween. The communication network may be formed as a wired network, a wireless network, or a combination thereof. The communication network may be formed as an Internet network. The created active content may be sent to the active content playback device 200 via the communication network.

FIG. 2 illustrates a hardware block diagram of an exemplary active content creation device 100.

Referring to FIG. 2, the active content creation device 100 includes an input interface 101, an output interface 103, memory 105, a hard disk 107, a communication interface 109, a Central Processing Unit (CPU) 111, and a system bus/control bus 113. The block diagram of FIG. 2 is a hardware block diagram, and a specific hardware block may be omitted in a modification to the design of the device. Also, other blocks, which are not illustrated in FIG. 2, may be further included in the active content creation device 100.

Simply describing the hardware configuration of the active content creation device 100 with reference to FIG. 2, the input interface 101 includes a mouse, a keyboard, a touchpad, a button, a microphone, and the like, and may receive input from a user. An input signal, received through the input interface 101, is delivered to the central processing unit 111.

The output interface 103 outputs a signal received from the central processing unit 111 by being connected to the central processing unit 111. The output interface 103 includes a display, a speaker, a buzzer, a vibrating element or the like, and may output audio or video signals depending on the signal received from the central processing unit 111.

The memory 105 includes volatile memory and/or non-volatile memory and stores various data and programs therein.

The hard disk 107 is a high-capacity storage medium and stores various data and programs therein.

The memory 105 and/or the hard disk 107 may store multiple pieces of content for inclusion in active content to be created by the active content creation device 100, as well as a content creation program for creating control code and intention parameters for the active content. Also, the memory 105 and/or the hard disk 107 may store control code to be embedded in active content or basic code for writing the control code.

The communication interface 109 sends and receives wired or wireless network signals through communication networks. The communication interface 109 includes circuits or logic for encoding and decoding signals according to designated wired/wireless communication protocols. The active content creation device 100 may send created active content to an external content server or the active content playback device 200 through the communication interface 109.

The central processing unit 111 executes program code. The central processing unit 111 loads program code, stored in the memory 105 and/or the hard disk 107, and executes the loaded code, whereby active content may be created.

Specifically, the central processing unit 111 loads a stored content creation program, executes the code of the loaded program, and combines the content with control code or basic code, stored in the memory 105 or the like, thereby creating active content. The central processing unit 111 includes an embedded processor that is capable of executing program code, and may process various programs and data. The central processing unit 111 may be referred to as a CPU, an MPU, or the like.

The system bus/control bus 113 sends and receives data between blocks within the active content creation device 100. The system bus/control bus 113 may be a parallel bus, a serial bus, General-Purpose Input Output (GPIO) or the like. The system bus/control bus 113 is controlled by the central processing unit 111, and may deliver data or signals from other blocks to the central processing unit 111, or may deliver data or signals from the central processing unit 111 to other blocks.

FIG. 3 illustrates a functional block diagram of an exemplary active content creation device 100.

Referring to FIG. 3, the active content creation device 100 includes an input unit 151, a parameter creation unit 153, a content loading unit 155, a control code configuration unit 157, a player control code configuration unit 159, a content binding unit 161, and a security method application unit 163, and the above-mentioned units are functional blocks for respectively performing an input process, a parameter creation process, a content loading process, a control code configuration process, a player control code configuration process, a content binding process, and a security method application process. FIG. 3 illustrates functional blocks, and each of the blocks may represent the function of each of the above-mentioned processes. Therefore, the description of each of the functional blocks may correspond to the description of each of the processes or the description of a method that includes each of the processes.

The functional blocks in FIG. 3 are implemented as a content creation program stored in the memory 105 and/or the hard disk 107.

The content creation program creates active content using the hardware blocks of the active content creation device 100. Specifically, the central processing unit 111 may load the content creation program, execute the code of the loaded program, create and store active content using the input interface 101, the output interface 103, the memory 105, the hard disk 107 and the like, and send the created active content to a communication network through the communication interface 109.

Describing each of the functional blocks of the active content creation device 100 in FIG. 3, the input unit 151 receives input from a user using the input interface 101 and the output interface 103. For example, the input unit 151 creates an image for prompting a user to enter an input and outputs the created image through the output interface 103. The input unit 151 is configured to receive a signal, which is input through the created image, and to input or select data in response to the signal.

Specifically, the input unit 151 may output a screen in which content to be included in active content can be selected, that is, a screen for browsing content, through the output interface 103. Also, the input unit 151 may output a screen in which one or more intention parameters to be used for the management of content, which is to be included and selected in the active content, can be input, through the output interface 103.

For example, the screen for selecting content may be a screen for browsing and selecting a content file, and the screen for inputting intention parameters may include a checkbox, an input window for setting the values of intention parameters, and the like.

The intention parameter is set by the producer (creator) of the active content in order to manage the content. One or more intention parameters may be related to the playback of content or the distribution of the content. In other words, the intention parameter is configured to control at least the playback or the distribution of the content. A single intention parameter may be related to either playback of content or distribution of content, and may be related to both playback and distribution. The intention parameter may be a value for directly controlling playback or distribution, or may be represented as a factor.

The intention parameter may represent, for example, whether or not content can be played, the number of times content can be played, and/or a time limit until which content can be played, or may represent whether or not content can be distributed, the number of times content can be distributed, and/or a time limit until which content can be distributed. Alternatively, the intention parameter may be represented as a factor, for example, a memory factor or a forgetting factor for limiting the distribution or playback of content according to memory or forgetfulness. The number of times content can be played or distributed or the time limit until which content can be played or distributed may be determined depending on the memory factor or the forgetting factor. The memory factor or the forgetting factor may be selectively embedded as an intention parameter or together with data such as the number of times or the time limit. The two kinds of parameters may be used together in such a way that the quality of embedded content is controlled depending on the current value of the memory factor or the forgetting factor when a condition, such as the number of times that the content can be played or distributed and the time limit until which the content can be played or distributed, is satisfied.

The input unit 151 may receive input for one or more intention parameters and the selection of content to be embedded (included) in active content through the selection or input in the output screen or window.

The parameter creation unit 153 creates one or more intention parameters to be embedded in active content depending on the input for the one or more intention parameters, received by the input unit 151. The created intention parameters are expressed using a markup language for representing intention according to the present invention. Here, the markup language (hereinafter, referred to as Intention Markup Language (InML)) is defined in order to represent the intention of a content producer to the content embedded in active content.

The parameter creation unit 153 creates parameter data from one or more parameters represented using the defined markup language. The created parameter data may be embedded in active content, and may be modified depending on the use of the content.

The content loading unit 155 loads the content selected through the input unit 151 in the memory 105 at the designated location or in the internal memory or register of the central processing unit 111. The loaded content is combined with other control code and then contained in the active content.

The control code configuration unit 157 configures content control code, which is executable by a computer, for controlling the embedded content, depending on the one or more intention parameters created by the parameter creation unit 153. The control code configuration unit 157 creates content control code, in which the created intention parameters are included or in which the created intention parameters are applied, using control code or basic code stored in the memory 105 and/or the hard disk 107. The created content control code is configured to initialize the one or more intention parameters or to read the one or more intention parameters (to point to the intention parameters). If the initial values of the intention parameters are included in the content control code, the process of storing the intention parameters in the active content may be skipped.

The control code configuration unit 157 configures content control code depending on the one or more created intention parameters. For example, the content control code may be configured to include control code for reading and processing intention parameters in which the intention of the producer is reflected. Accordingly, control code that operates depending on a specific parameter that is not an intention parameter may not be included in the content control code to be configured. Furthermore, the control code configuration unit 157 may reflect the type of intention parameter (a factor, the time limit, or the like) when creating the content control code.

The player control code configuration unit 159 configures player control code for controlling a player depending on the one or more embedded intention parameters, the player being included in the playback device 200 or active content and being capable of playing content embedded in the active content.

The player is a program used to play content on the software platform of the active content playback device 200, and may be included in the active content or installed in the active content playback device 200. The player may decode content based on the type thereof, and may output audio or video signals through the active content playback device 200.

The player control code configuration unit 159 may raise or lower the quality of content according to a specific intention parameter when the content is played. For example, embedded content may be deleted or the quality thereof may be raised or lowered based on the current memory factor or forgetting factor in the active content playback device 200 after the distribution of the content or depending on data such as the number of times the content can be distributed or played or the time limit until which the content can be distributed or played. Also, in order to control the quality, a reversible watermarking technique may be applied to the embedded content. By applying the reversible watermarking technique, the content may be output with low quality as if the content were aged, or may be reconstructed so as to have high quality according to changes to the situation.

The content binding unit 161 creates active content by combining the content loaded by the content loading unit 155, the content control code created by the control code configuration unit 157, the player control code created by the player control code configuration unit 159, and one or more intention parameters together.

The content binding unit 161 creates active content according to the appointed format, and the created active content is recognized as an executable file on the designated software platform. To this end, the active content includes at least the OS header of the corresponding software platform. The OS header may correspond to a Windows header, a Linux header, or the like.

The active content may be configured according to the appointed definition. For example, the active content may be configured using a markup language defined according to the present invention. This markup language may be InML or a language that includes InML specifications.

The security method application unit 163 applies a designated security method to active content in order to prevent the embedded content from being extracted from the active content or from being modified, or to prevent the functions of the embedded control code from being extracted from the active content or from being modified.

The security method application unit 163 applies a designated security method to one or more selected from among the one or more intention parameters, the content control code, the player control code and/or the embedded content, thus preventing arbitrary forgery, falsification, or extraction. Here, the security method may be configured as, for example, an obfuscation method, a polymorphic method, or a combination thereof.

Thanks to the application of a security method, active content may be created such that the falsification thereof or extraction of the embedded content therefrom is difficult. The created active content may be played according to the embedded intention, or may be distributed through communication networks. Also, the active content may be stored in a computer-readable recording medium and may then be distributed. Here, the recording medium is a medium in which data or programs can be stored, such as USB memory, a CD, a DVD, an SD card, a removable hard disk, or the like.

FIG. 4 illustrates a block diagram of an exemplary active content playback device 200.

Referring to FIG. 4, the active content playback device 200 includes an input unit 201, an output unit 203, a communication unit 205, a storage unit 207, an execution unit 209, and a connection unit 211. Some of these blocks may be omitted in modifications to the design of the device. Also, other blocks, not illustrated in FIG. 4, may be further included in the block diagram of FIG. 4 depending on modifications to the design of the device.

Describing the active content playback device 200 with reference to FIG. 4, the input unit 201 receives input from a user who attempts to play or distribute active content. The input unit 201 may include, for example, a keyboard, a mouse, a microphone, a touchpad, a button, and the like. Through the input unit 201, the stored active content may be requested to be played or to be copied, or may be distributed to another active content playback device 200.

The output unit 203 outputs audio or video signals by being connected to the execution unit 209. The output unit 203 includes, for example, a display for outputting video signals and an earphone jack or speaker for outputting audio signals, and may output the audio or video signals of the content that is being played.

The communication unit 205 sends and receives data through communication networks. The communication unit 205 may receive active content from a content server or an active content creation device 100, or may send active content to another active content playback device 200 through the communication networks in response to a request by a user.

The communication unit 205 includes a circuit or logic for encoding and decoding communication packets, received from wired or wireless near-field communication networks, and may send and receive the communication packets using wired or wireless media.

The storage unit 207 includes a high-capacity storage medium, such as non-volatile memory and/or a hard disk, and stores various data therein. For example, the storage unit 207 stores one or more pieces of active content that operate according to the intention of a content producer. Here, the active content includes one or more intention parameters, which are expressed using an appointed markup language and are used to manage the content embedded in the active content, content control code for controlling the content depending on the intention parameters, and player control code for controlling an external player depending on the intention parameters.

The storage unit 207 also includes various players (player programs) used for playing content. Here, the players may be loaded in the execution unit 209, and may output audio or video signals through the output unit 203 by executing a specific type of content.

The execution unit 209 receives input from a user through the input unit 201, loads active content, which is selected depending on the input from the user and is recognized as an executable file on the OS, that is, the software platform of the active content playback device 200, and manages content, which is embedded in the active content and can be played through a player, depending on the intention parameters recognized by the active content.

The execution unit 209 has one or more processing units that are capable of executing instructions of program code. The execution unit 209 operates an OS program and recognizes active content as an executable file based on the OS header included in the corresponding active content by parsing the active content on the OS program. Because the active content is recognized as an executable file, the execution unit 209 may execute the instructions of the content control code that follows the OS header. Before this process, the execution unit 209 may release the security scheme that has been applied to the active content.

The execution unit 209 controls actions taken on the embedded content depending on one or more intention parameters, which are parsed through the content control code. For example, the execution unit 209 parses the time limit until which content can be played or the number of times content can be played and allows playback of the content, requested through the input unit 201, if the current date is earlier than the parsed time limit or if the parsed number of times that the content can be played has not been reached. Also, the execution unit 209 parses the time limit until which content can be distributed or the number of times content can be distributed and allows the distribution of the content, requested through the input unit 201, if the current date is earlier than the parsed time limit or if the parsed number of times that the content can be distributed has not been reached.

The execution unit 209 may execute an action, such as requested playback or distribution of content, depending on the parsed memory factor or forgetting factor. The action may be executed differently depending on the parsed memory factor or forgetting factor. For example, if the forgetting factor is greater than a predetermined threshold or if the memory factor is less than the predetermined threshold, the content control code may control the player control code in order to play the content while lowering the quality thereof. If the forgetting factor is low and the memory factor is high, the player control code may be controlled in order to play the content while raising the quality thereof.

When the distribution or playback of content is allowed, the execution unit 209 modifies the intention parameter related to the corresponding action through the content control code, and may contain the modified intention parameter in the active content. Alternatively, the current value of the parameter, resulted from the performed action, may be separately stored in the active content. In other words, as the allowed action is performed, the active content may again store the intention, in which the result of the action is applied.

The execution unit 209 executes the player control code when the requested action (for example, distribution or playback) is allowed through the content control code. The player control code executed by the execution unit 209 is configured to call the player stored in the storage unit 207 and to input (provide) the embedded content to the player.

Accordingly, the execution unit 209 loads a player program from the storage unit 207 according to the player control code and plays the content embedded in the active content using the loaded player program. The quality of the content, provided to the player through the player control code, may be controlled depending on the forgetting factor, memory factor, or other parsed intention parameters. When playback of the content finishes, the quality of the content may be controlled again. For example, when the content is played, the forgetting factor may decrease and the memory factor may increase, and the content control code may store the factor as the modified intention parameter. When the content is played again, the content having the quality corresponding to the modified factor may be played by the player.

As described above, according to the control of the action on the content, the execution unit 209 modifies the value of the intention parameter related to the corresponding action, selected from among various intention parameters embedded in active content, and stores the modified intention parameter in the active content. Accordingly, the active content may reflect the intention of the content producer in connection with the action.

The connection unit 211 sends and receives data between the blocks within the active content playback device 200. The connection unit 211 may be, for example, a parallel bus or a serial bus. The connection unit 211 may send data to another block and receive data from the other block under the control of the execution unit 209.

As described above, the method for creating active content and a computer-readable recording medium in which the active content is stored according to the present invention may produce and play active content, in which content is combined with code to control the content, which is a departure from the concept of conventional content.

Also, the method for creating active content and a computer-readable recording medium in which the active content is stored according to the present invention may enable the intention of a content producer to be contained in the active content, whereby content embedded in the active content may be managed and played according to the intention.

Also, the method for creating active content and a computer-readable recording medium in which the active content is stored according to the present invention reject an existing management method based only on the determination of whether to retain or delete content and enable analog memory and forgetting to be applied to the active content for the management thereof.

The effect achieved by the present invention is not limited to the above-mentioned effects, and other effects that have not been mentioned may be clearly understood by those who are skilled in the art.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A method for creating active content, executed by a computer, comprising:
a parameter creation procedure for creating one or more intention parameters to be used to manage content;
a control code configuration procedure for configuring content control code for controlling content depending on the intention parameters, the content control code being executable by a computer; and
a content binding procedure for creating active content, in which the content control code is embedded, by combining the content control code with loaded content.

2. The method of claim 1, further comprising
an input procedure for receiving input for the one or more intention parameters and a selection of content to be loaded from a content creator,
wherein in the control code configuration procedure, the content control code is configured depending on the one or more intention parameters, which are set depending on the input.

3. The method of claim 1, wherein
the one or more intention parameters include a playback parameter related to playback of content and a distribution parameter related to distribution of content, and
the playback parameter and the distribution parameter are each represented as a number of times or a time limit.

4. The method of claim 1, further comprising
a player control code configuration procedure for configuring player control code for controlling a player, which is capable of playing the content, depending on the one or more intention parameters,
wherein in the content binding procedure, the active content is created by combining the player control code, the content control code and the loaded content.

5. The method of claim 4, further comprising
a security method application procedure for changing the intention parameters, the content control code, or the content, which are combined in the active content, based on a designated security method in order to prevent the one or more intention parameters, the content control code, or the content from being modified or from being extracted from the active content.

6. The method of claim 5, wherein the security method is an obfuscation method, a polymorphic method, or a combination thereof.

7. The method of claim 4, wherein in the content binding procedure, an Operating System (OS) header according to a designated software platform is further combined with the active content, and
the active content is recognized as an executable file on the designated software platform.

8. A computer-readable recording medium in which active content is stored,
wherein the active content comprises:
content that is capable of being played by a player; and
content control code for controlling the content depending on an intention parameter, the content control code being executable in a computer,
wherein the intention parameter is set to control at least playback or distribution of the content.

9. The computer-readable recording medium of claim 8, wherein:
the intention parameter is expressed using a designated markup language, and
an action on the content is controlled depending on the intention parameter.

10. The computer-readable recording medium of claim 9, wherein the active content further comprises player control code for controlling the player depending on the intention parameter.

11. The computer-readable recording medium of claim 10, wherein:
the active content further comprises an OS header according to a designated software platform,
the active content is recognized as an executable file on an OS of the software platform, and
the content is managed according to the content control code and the player control code within the active content.

12. The computer-readable recording medium of claim 9, wherein a value of the intention parameter is changed depending on control of the action on the content, and
the changed intention parameter is stored in the active content.

13. The computer-readable recording medium of claim 8, wherein the intention parameter, the content control code, or the content is changed based on a security method in order to prevent the intention parameter, the content control code, and the content from being modified or from being extracted from the active content.
